(19) United States
(12) Patent Application Publication
(10) Pub. No.: US 2019/0046953 A1
(43) Pub. Date: Feb. 14, 2019

(54) Synthesis of a Novel Ordered Mesoporous Carbon Using COK-19 Template for Water and Wastewater Treatment

(71) Applicant: University of Louisiana at Lafayette, Lafayette, LA (US)

(72) Inventors: Daniel Dianchen Gang, Lafayette, LA (US); Zaki Uddin Ahmad, Lafayette, LA (US); Mark E. Zappi, Lafayette, LA (US)

(21) Appl. No.: 16/053,084

(22) Filed: Aug. 2, 2018

Related U.S. Application Data
(60) Provisional application No. 62/543,595, filed on Aug. 10, 2017.

(51) Int. Cl. B01J 20/20; B01J 20/28; B01J 20/30; B01J 20/32; C02F 1/28; B01D 53/02

(52) U.S. Cl. CPC B01J 20/20; B01J 20/28083; B01J 20/3057; B01J 20/3078; B01J 20/3204; C02F 2101/10; B01J 20/28064; B01J 20/28073; C02F 1/283; B01D 53/02; B01J 20/324

(57) ABSTRACT

Ordered mesoporous carbon was prepared using COK-19 silica template. Ordered mesoporous silica COK-19 was synthesized with cubic Fm3m structure. Sucrose as the carbon precursor was impregnated into the mesopores of silica and converted to carbon through carbonization process using sulfuric acid as a catalyst. Ordered mesoporous carbon was obtained after the removal of silica framework using hydrofluoric acid. Several characterization techniques such as nitrogen adsorption-desorption isotherms, transmission electron microscope (TEM), Fourier transform infrared spectroscopy (FTIR), Raman spectroscopy, and elemental analysis were employed to characterize the OMC. The pore size analysis and TEM images confirmed that OMC has replicated the mesostructure of the COK-19. Results obtained from adsorption kinetics and isotherms suggest that the Pseudo-Second-Order Model and Langmuir Isotherm well described the experimental data. The adsorption study showed that the synthesized OMC has an adsorption capacity of 40.5 mg/g for resorcinol removal.

### CROSS REFERENCE TO RELATED APPLICATION

This application claims priority to the U.S. Provisional Application No. 62/543,595, titled “Synthesis of a Novel Ordered Mesoporous Carbon Using COK-19 Template for Water and Wastewater Treatment”, which was filed with the United States Patent and Trademark Office on Aug. 10, 2017.

### STATEMENT REGARDING FEDERALLY SPONSORED RESEARCH OR DEVELOPMENT

Not applicable.

### REFERENCE TO A “SEQUENCE LISTING”, A TABLE, OR COMPUTER PROGRAM

Table 1 provides a description of the textual parameters of COK-19 and OMC.

Table 2 presents results of elemental analysis of OMC.

Table 3 presents calculated coefficients of pseudo-first-order and pseudo-second-order kinetic models for resorcinol adsorption onto OMC.

Table 4 presents a summary of parameters calculated from fitting the results of adsorption isotherms of resorcinol onto OMC.

### DESCRIPTION OF THE DRAWINGS

FIG. 1 provides a schematic diagram of OMC preparation.

FIG. 2(a) presents N₂ adsorption-desorption isotherm of COK-19 and OMC.

FIG. 2(b) presents pore size distribution of COK-19.

FIG. 2(c) presents pore size distribution of OMC.

FIG. 3(a)-3(b) present TEM images of COK-19 and mark OMC.

FIG. 4 presents a FT-IR Spectra of OMC.

FIG. 5 presents a Raman Spectra of OMC.

FIG. 6 provides a comparison the influence of contact time on resorcinol adsorption (C₀: 10 mg/L, T: 25° C., pH: 6.1, Adsorbent dosage: 0.1 gm/L).

FIG. 7(a) presents a linearized form of a pseudo-first-order kinetic plot for resorcinol adsorption onto OMC (C₀: 10 mg/L, T: 25° C., pH: 6.1, Adsorbent dosage: 0.1 gm/L).

FIG. 7(b) presents a linearized form of a pseudo-second-order kinetic plot for resorcinol adsorption onto OMC (C₀: 10 mg/L, T: 25° C., pH: 6.1, Adsorbent dosage: 0.1 gm/L).

FIG. 8(a) presents a linearized form of Langmuir isotherms for resorcinol adsorption onto OMC (C₀: 10 mg/L, T: 25° C., pH: 6.1, Contact time: 24 hour).

FIG. 8(b) presents a linearized form of Freundlich isotherms for resorcinol adsorption onto OMC (C₀: 10 mg/L, T: 25° C., pH: 6.1, Contact time: 24 hour).

### FIELD OF THE INVENTION

The present invention relates to the general field of waste water treatment, especially as it relates to adsorption of organic and inorganic compounds. The invention relates generally to carbon based adsorption media. In particular, the invention relates to a method to produce and the composition of an ordered mesoporous carbon.

### BACKGROUND OF THE INVENTION

Water pollution due to contaminants originating from industrial sources is a matter of significant interest and concern. The main sources of water pollution are attributable to the discharge of industrial wastewaters containing substances that cannot be easily removed by conventional treatment processes. Some of these industrial effluents are subjected to special regulations because of their higher toxicity level. Phenolic compounds and their derivatives such as catechol (C), resorcinol (R), and hydroquinone (HQ) are common environmental pollutants because of their wide use in pharmaceuticals, plastic, steel, paint, leather and oil refinery industries as solvents. These compounds were also found in the wastewater of synthetic coal fuel conversion processes. The United States Environmental Protection Agency (USEPA) has included phenols and phenolic compounds under the priority pollutant list. Due to their high toxicity in nature, higher oxygen demand (theoretically 2.4 mg O₂ mg-1 phenol) and low natural biodegradability, phenolic compounds are considered as the primary pollutants. A concentration of phenol exceeding 2 mg/L is toxic to fish and concentration ranging from 10 to 100 mg/L can cause detrimental effects to aquatic life. It is therefore necessary to remove or eliminate these compounds from wastewater before discharge to water bodies or reuse.

Several techniques have been developed to remove organic and inorganic adsorbates from wastewater including adsorption, biological treatment, chemical oxidation, electrochemical precipitation, solvent extraction, and metal complexation. Adsorption is considered to be a cost-effective technique for treating wastewater with pollutants at low concentrations. Adsorption process possesses several advantages: low operation cost, simplicity of design and operation, and ability to operate at a very low concentration. If the adsorption process is designed correctly, a high quality treated effluent can be produced. Some drawbacks associated with the adsorption process are: this technique can have a high initial cost and it is a non-destructive technique.

Granular activated carbon (GAC) has been widely used as an adsorbent for its high adsorption capacity due to its high specific surface area and large pore volume, and its modified surface chemistry that helps to achieve a higher adsorption capacity. Practically, a larger fraction of pores exist as micropores (pores having diameter of less 2 nm) in commercial activated carbons and these are inaccessible to most of the large molecular organic matter in the waste streams. The inaccessibility of the adsorption sites to the adsorbates (pollutants) can lead to low adsorption capacity and slow adsorption kinetics.

A Mesoporous material, according to the IUPAC definition, is a material possessing pore size ranging from 2 to 50 nm. Mesoporous carbons have successfully drawn much attention due to their higher surface area and tunable pore size. Mesoporous carbon has been identified as an excellent candidate for adsorption because of their higher specific surface area and larger pore volume which can be easily accessed by the adsorbate. The increase in pore size can also significantly improve adsorption kinetics. Mesoporous carbons can be synthesized from mesoporous silica scaffolds such as MCM-48 and KIT-6 (cubic Ia3d), SBA-16 (cubic Im3m), KIT-5 and FDU-12 (cubic Fm3m), SBA-15 (2D hexagonal p6 mm) using different carbon precursors. The synthesized carbon replicas have higher specific surface area, larger pore volume and tunable pore diameter with different structures, such as hexagonal, cubic, large cage type and wormhole like. Mesoporous carbon is effective in removing organic and inorganic contaminants from both liquid and gaseous streams.

### DETAILED DESCRIPTION OF THE INVENTION

This application describes the synthesis of ordered mesoporous carbon (OMC) using mesoporous silica as the template to provide structure. In this example, sucrose is used as a carbon source, but other sources of carbon can be used. Also in this example, a highly ordered mesoporous silica referred to as “COK-19” was used. COK-19 was synthesized and reported by S. Kerkhols, et al. in 2015 with cubic Fm3m structure.

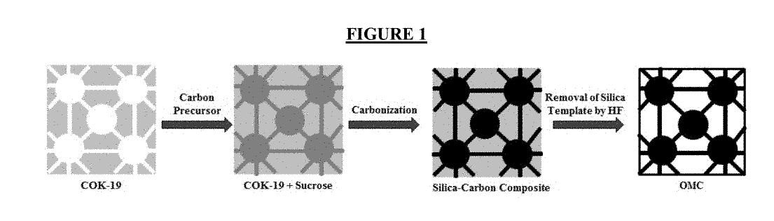

The procedure involved was impregnation of an appropriate carbon precursor into the mesopores of silica template followed by thermal polymerization, carbonization, and subsequent removal of silica framework by hydrofluoric acid. The synthesis procedure was modified from the original literature (J. Xu et al., 2014) and experimental conditions were adopted (amount of reactants, reactants used, temperatures etc.). Although directed toward removal of both organic and inorganic absorbates, in one example, resorcinol was used as a model compound to evaluate the adsorption efficiency of the OMC. FIG. 1 illustrates the step by step fabrication process of OMC. The adsorption capacity was studied using batch adsorption method and fitted to Langmuir and Freundlich Adsorption Models. The adsorption kinetics was also studied and fitted to Pseudo-First-Order Kinetic Model and Pseudo-Second-Order Kinetic Model.

Materials used in the examples include a copolymer, hydrates, a source of silica, a source of carbon, and acids: Triblock copolymer Pluronic F-127 (M_{w}=12600, EO₁₀₆-PO₇₀-EO₁₀₆, EO=ethylene oxide, PO=propylene oxide), citric acid monohydrate (ACS reagent, ≥99%), trisodium citrate dihydrate, sodium silicate solution (reagent grade, SiO2 27%), Sucrose (ACS reagent, ≥99.0%), sulfuric acid (ACS reagent, 98%), and hydrofluoric acid (ACS reagent, 48%). Whereas OMC in the examples was generated using reagent grade chemicals, industrial grade chemicals could also be used.

In addition, materials that perform the same function could be substituted when producing OMC. The following examples of alternate materials are non-exclusive. Examples of other copolymers that could be used include Pluronic P123, Brij® 58, Brij 76. Likewise, sources of silica could include Tetraethyl Orthosilicate (TEOS). Sources of carbon that could be substituted include acrylic acid, acrylamide, glucose, furfuryl alcohol, mixture of ethylenediamine and carbon tetrachloride. Finally, other acids, including, phosphoric acid (H₃PO₄), nitric acid (HNO₃), hydrochloric acid (HCl) could be substituted.

The COK-19 material used in this example was synthesized using Pluronic F-127 triblock copolymer surfactant and sodium silicate solution as the silica source. In a typical synthesis, 2.6 gm of Pluronic F-127 was dissolved in 107.5 gm of deionized water. To this solution, 3.7 g of citric acid monohydrate and 2.55 gm of trisodium citrate dihydrate were added. This buffered surfactant solution was stirred overnight to dissolve all the components. After that, 10.4 gm of sodium silicate solution (26.5% SiO₂) diluted in 30 gm of water was added to the buffered F-127 solution at room temperature and the solution was stirred vigorously for 5 minutes (min). Precipitation of white solid occurred instantaneously and the milky white suspension was kept under quiescent conditions for aging for 24 hour (hr) at a temperature of 70° C. in a constant temperature water bath (Premiere HH-4). Afterwards, the white precipitation was filtered off, washed with deionized water (4,000 mL) and dried in the oven at 105° C. overnight. After drying, the resultant solid was calcined at 350° C. for 24 hr using a heating rate of 0.5° C./minute in a box furnace. The white COK-19 silica template was stored in the desiccator for the preparation of OMC.

The ordered mesoporous carbon produced in this example was obtained by the hard-template method, using COK-19 as the hard template and sucrose as the carbon precursor. The silica template was subjected two times to impregnation with a carbon solution. More or less impregnations could be used as required to create the desired carbon content. Here, the carbon solution is sucrose, dissolved in an acidic aqueous solution. The process could utilize other sources of carbon and other solvents.

In one example, 1.7 gm of sucrose (99.5% wt.) and 15 drops of H₂SO₄ is dissolved in 15 mL of distilled water. After adding 2.0 gm of COK-19, the mixture is heated to remove the water. In this example, the mixture is 100° C. for 6 hr and subsequently to 160° C. for another 6 hr. In other examples, the heating temperature range could be from 70° C. to 200° C. Alternate heating programs could be used to evaporate the solvent (water in this example), as long as temperature is sufficiently low as to prevent denaturing of the materials and avoids rapid evaporation that will damage the structure. Thermal polymerization converts a monomer molecule into a polymer chain or three-dimensional network with the application of heating. The resulting dark-brown solid composite can be subjected to subsequent impregnations. After the heat treatment at 100° C. and 160° C. (or a functionally equivalent program) once again as before, the composite was subjected to carbonization at significantly higher temperatures and in an oxygen deficient atmosphere. In one example the composite is heated to 700° C. for 8 hr under nitrogen flow. In other examples, the carbonization temperature range could be from 450° C. to 900° C. for 3 to 9 hr. Thereafter, the silica template was removed using an acid, such as HF, capable of dissolving the silica template without affecting the carbon. The obtained product (OMC) is then filtered and cleaned, in this example with deionized water.

Samples of the OMC were analyzed for chemical and physical properties. Nitrogen sorption isotherms of the product obtained by the previously discussed examples were recorded on an Accelerated Surface Area and Porosimetry System. Specific surface areas of the samples were calculated using the BET (Brunauer-Emmett-Teller) Equation, while pore size distribution (PSD) curves were calculated by the BJH (Barrett-Joyner-Halenda) Method using the adsorption branch. Prior to measurement, OMC was degassed at 300° C. for 6 hr under reduced pressure. The total pore volume was obtained from the amount adsorbed at a relative pressure (P/P₀) of 0.99, where P and P₀ are equilibrium and saturation pressure of adsorbates.

Transmission electron microscopy (TEM) images were obtained using electron microscopy. The acceleration voltage used was 100 kV. The samples were prepared by dispersing many particles in ethanol with an ultrasonic bath for 15 min and a few drops of the resulting suspension were placed on a 400 mesh Cu grid.

Fourier Transform Infrared (FT-IR) spectra of the samples were collected in transmission mode from KBr pellets at room temperature on a Jasco 4700 spectrometer with a resolution of 4 cm⁻¹, using 32 scans per spectrum in the region of 400-4000 cm⁻¹. The mass ratio of every sample to KBr was constant at 1:200. A Raman spectrum was obtained using a Raman laser. The sample was scanned in the range of 200-2800 cm⁻¹.

Element composition analysis was obtained using an elemental analyzer. Sulfanilic acid was used as a standard for reference. Combustion and reduction tube temperatures were set at 1,150° C. and 850° C., respectively.

The content of oxygen containing functional groups on the surface of mesoporous carbon was determined by the Boehm method. Different bases such as NaHCO₃, Na₂CO₃, and NaOH were used. In this example, 10 mg of OMCs were added to 40 mL of the 0.05 M acid and 0.05 M basic solutions in flask. The flasks were sealed and shaken for 24 hr at 275 rpm. The samples were filtered using 0.45 μm filter papers. Then 5 mL of the filtrate was transferred to 50 mL beaker using pipette. HCl and NaOH solutions with concentration of 0.05 M were then used to neutralize the filtrate. The number of acidic functional groups was calculated following the assumption that NaOH neutralizes all acidic groups and HCl reacts with basic groups. The presence of this oxygen containing surface function group, specifically carboxylic group, can adsorb organic compounds through the formation of hydrogen bonding.

To illustrate the adsorption capacity of organic and inorganic absorbent of prepared ordered mesoporous carbon, batch adsorption experiments were conducted using resorcinol as an example compound. For that purpose, 100 mL of resorcinol solution with a concentration of 10 mg/L at pH value of 6.1 was placed in 250 mL conical flasks for both control (without OMC labeled as blank) and experimental (with OMC and adsorbate) conditions. All the samples were placed in an E24 incubator shaker. The adsorption studies were conducted at room temperature of 25° C. and the shaking speed was maintained at 250 rpm. After 24 hr, the conical flasks were removed from the shaker and the solution was filtered using 0.45 μm glass filter paper. The blank solution was used as a reference to establish the initial concentration for the solutions containing OMCs. The concentration of resorcinol was determined using a UV-visible spectrophotometer set at a wavelength of 500 nm. The amount of resorcinol adsorbed by OMCs was determined by subtracting the final concentration from the initial concentration using the following formula:

$${Q}_{e} = \frac{( {C}_{0} - {C}_{e} ) V}{M}$$

Where Qₑ is the adsorption capacity (mg/g) of the adsorbent at equilibrium, Cₒ is the initial concentration of resorcinol in the solution (mg/L), Cₑ is the final concentration of resorcinol in the treated solution (mg/L), V is the volume of the solution taken (L), and M is the weight of the adsorbent OMC (g).

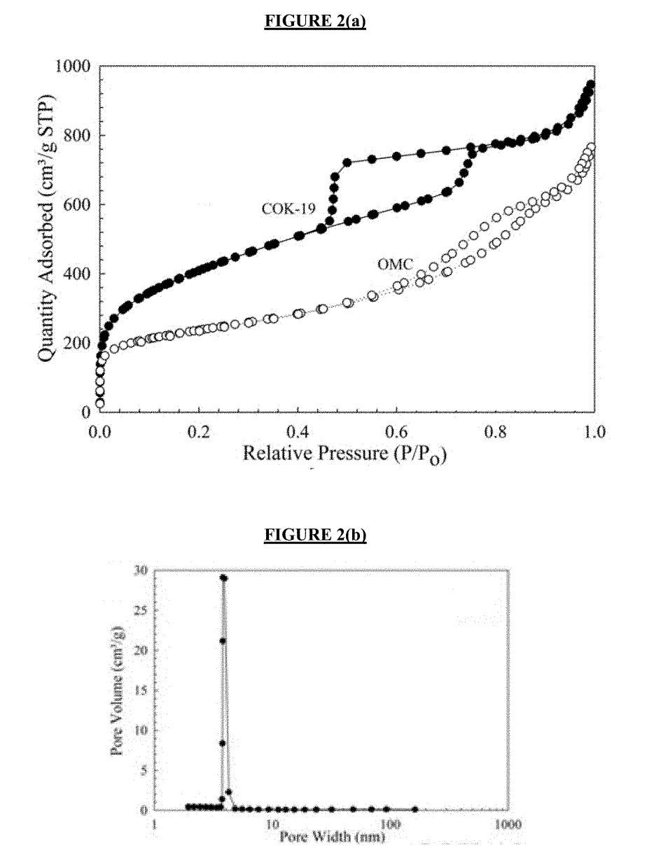

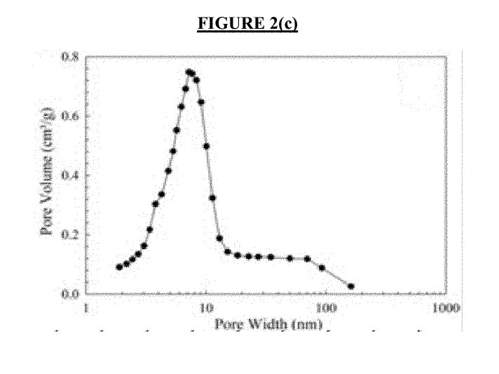

The N₂ adsorption-desorption isotherms of COK-19 behave like representative Type IV curves with a sharp capillary condensation step in the relative pressure range of 0.65-0.75 as shown in FIG. 2(a). The COK-19 capillary condensation step is located in the smaller relative pressure range that can be interpreted to narrow pore size distribution, which is confirmed by the pore size distribution as depicted in FIG. 2(b). FIG. 2(a) also shows the nitrogen adsorption-desorption isotherm of synthesized OMC. The prepared OMC exhibits typical isotherm of Type IV of ordered mesostructure with a relatively wide nitrogen uptake step at P/P₀ between 0.60 and 0.85, indicating the presence of mesopore framework with a uniform size. Because of this reason, a relatively wide pore size distribution is observed for the OMC as shown in FIG. 2(c). The detailed textual parameters of COK-19 and OMC are summarized in Table 1. The specific surface area and pore size of COK-19 are 1481.15 m²/g and 6.1 nm, respectively. These results are similar to those of previously reported by Kerkholfs et al. OMC possesses specific surface area and pore size of 1014.3 m²/g and 6.9 nm, respectively. It is noteworthy that pore volume as well as pore size are superior to the corresponding values obtained for other OMC materials which employed diverse mesoporous silica materials (e.g. SBA-15, MCM-48, KIT-6) as templates. Sucrose is carbohydrate precursor that can form non-graphitic carbon structure after pyrolysis. The non-graphitic carbon structure has higher tendency to collapse resulting in larger pore size having less ordered structure. Similar observations were reported by Joo et al. It can be concluded that the introduction of carbon precursor into the mesopores of COK-19 favorably creates ordered mesoporous carbon.

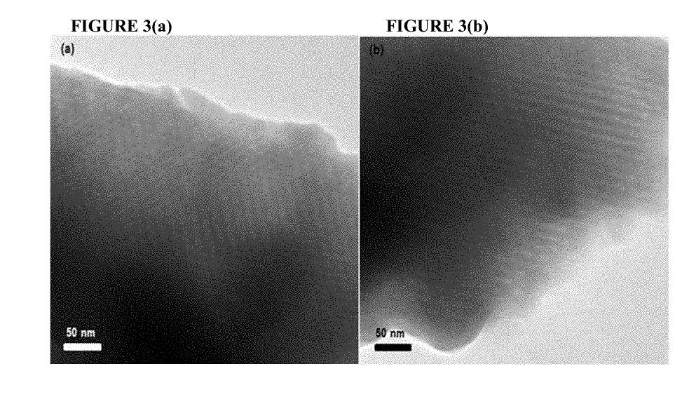

FIG. 3(a) shows the TEM images of COK-19 silica template. The images show uniformly arranged pore structure that corresponds to the cubic Fm3m structure observed for COK-19 (as described by Kerkholfs et al.). TEM image of the OMC prepared using COK-19 silica template is shown in FIG. 3(b) reveals an ordered arrangement of mesopores. Combining pore size distribution and TEM images of prepared OMC, it can be confirmed that the OMC has well replicated the mesostructures of the COK-19 template.

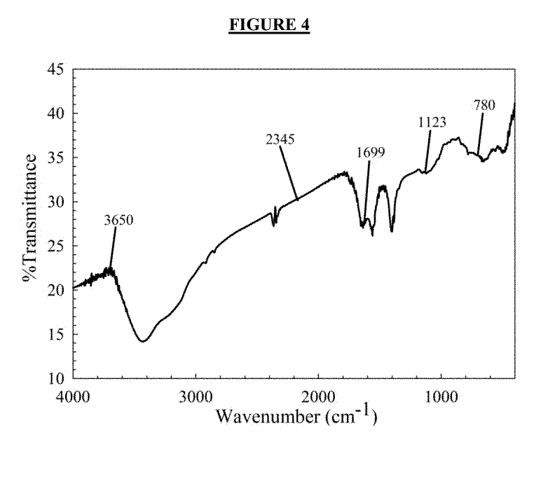

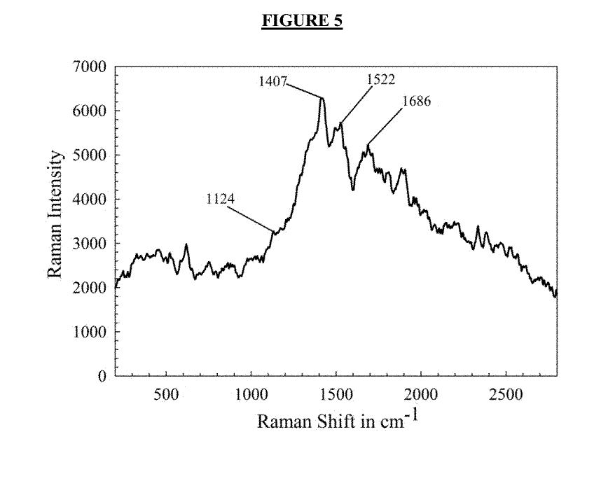

The functional groups were identified using FT-IR. FIG. 4 shows the FT-IR spectra of the prepared OMC sample. Literature suggests that the peaks were observed around 3,650-3,775 cm⁻¹ which could be assigned to O—H stretching group; a set of peaks observed around 1,699-1,734 cm⁻¹ could be related to C═O stretching group; a week peak observed at 2,345 cm⁻¹ could be ascribed to S—H due to the presence of sulfuric acid that acted as a catalyst in the preparation process; and, a peak observed at 1,123 and 780 cm⁻¹ could be associated to S═O and C—H group, respectively. FIG. 5 shows the Raman spectra of synthesized ordered mesoporous carbon. It can be seen from the spectra that G band is present at the shift of 1,522 cm⁻¹ followed by D band at the shift of 1,407 cm⁻¹. Literature suggests that the presence of G band can be attributed to the graphitic structure of ordered mesoporous carbon, whereas D line indicates the truncation of graphitic structure which is most common for carbonaceous structure; the peaks observed around 1,686 cm⁻¹ could be attributed to C═O stretching group; and, the small peaks observed around 1,124 cm⁻¹ could be assigned to C—H bending. The results obtained from Raman spectra were found to be consistent with FTIR analysis.

Results of elemental analysis and Boehm titration of the OMC are represented in Table 2. The percentage of carbon, oxygen, hydrogen and sulfur was found to be 83.6%, 12.98%, 2.98% and 0.45%, respectively. The elemental analysis, as expected, indicated that carbon was the most dominant element, followed by oxygen. Again, the sulfur present on the OMC could be due to the addition of sulfuric acid in the fabrication process. The amount of carboxylic, lactonic and phenolic group was 0.46 mmol/g, 0.012 mmol/g, and 0.065 mmol/g, respectively. The result obtained from the Boehm titration was found to be consistent with the FTIR analysis where C═O stretching group was believed to be originated from carboxylic functional groups. The peak of O—H group originated from phenolic groups. Similar observations were reported by Kim et al.

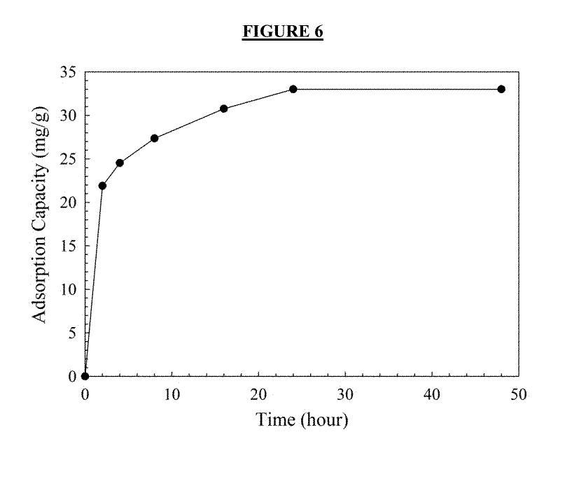

The adsorption process as a function of time was studied from adsorption experiments of resorcinol onto the OMC. The results are shown in FIG. 6. Results indicate that the time required to reach equilibrium is 24 hr. Therefore, the contact period was kept 24 hr for the adsorption analysis.

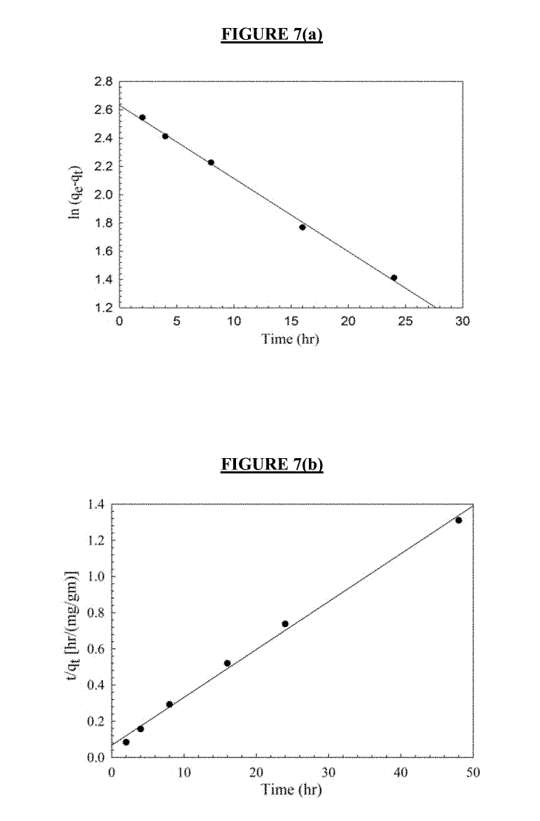

The pseudo-first-order and pseudo-second-order models were used to evaluate the adsorption kinetics of resorcinol onto ordered mesoporous carbon. The Lagergren-First-Order Kinetic Model and Second-Order Kinetic Model are expressed by the following equations, respectively (A. Sari et al., and A. Y. Dursun et al.):

$$ln ( {q}_{e} - {q}_{t} ) = ln ( {q}_{e} ) - {k}_{1} t$$

$$\frac{t}{{q}_{t}} = \frac{1}{{k}_{2} {q}_{e}^{2}} + \frac{t}{{q}_{e}}$$

Where qₑ (mg/g) is the amount of resorcinol adsorbed at equilibrium, qₜ (mg/g) is the amount of resorcinol adsorbed by the adsorbent at any time, k₁ (hour⁻¹) and k₂ (g mg⁻¹ hour⁻¹) are the rate constants of the pseudo-first-order reaction and pseudo-second-order reaction, respectively. The fitting plots using the Pseudo-First-Order and Pseudo-Second-Order equations are shown in the FIG. 7. The value of k₁ was calculated from the plot of ln(qₑ−qₜ) versus t as shown in FIG. 7(a). Similarly, the value of k₂ was calculated from the linear plot of t/qₜ versus t as shown in FIG. 7(b). Experimental data revealed better compliance with the pseudo-second-order kinetic model based on higher correlation coefficients. The experimental value of qₑ is found to be closer to the calculated qₑ assuming the Pseudo-Second-Order Kinetic Model (Table 3). According to T. Chen et al. and Y. S Ho et al., the higher correlation coefficient for a Pseudo-Second-Order Equation implied that the removal of resorcinol onto OMC was closer to chemisorption.

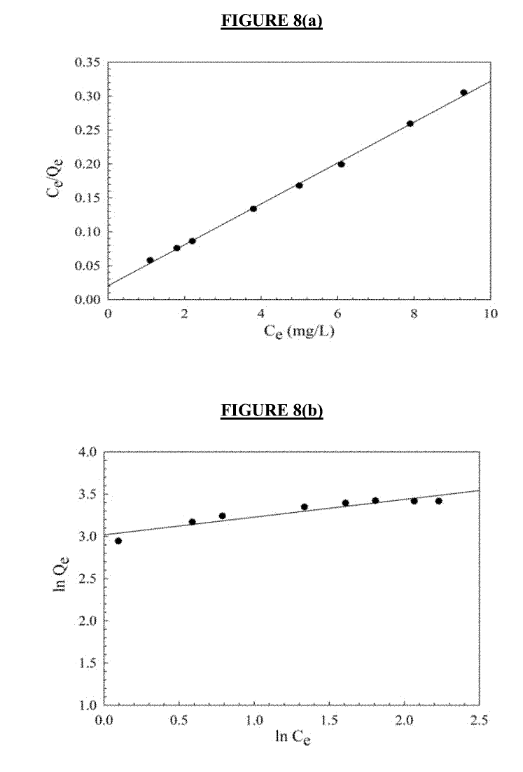

In order to describe the mechanism of interaction between adsorbate and adsorbent and reveal the adsorption capacity of the adsorbent, the equilibrium data were analyzed using the Langmuir and Freundlich Isotherm Models. The Langmuir Isotherm Model is based on the assumptions that single adsorbate binds to a single site on the adsorbent and all the sites on the surface of adsorbent have the same affinity to the adsorbate. The Langmuir Adsorption Isotherm is represented by the following linearized equation.

$$\frac{{C}_{e}}{{Q}_{e}} = \frac{1}{{Q}_{m} {K}_{L}} + \frac{{C}_{e}}{{Q}_{m}}$$

Where Qₘ is the maximum adsorption capacity, K_{L} is the Langmuir equilibrium constant (mg/g), Cₑ is the equilibrium concentration and Qₑ is the equilibrium adsorption amount (mg/g). A linearized plot was obtained when Cₑ/Qₑ was plotted against Cₑ over the entire concentration range evaluated as shown in FIG. 8(a). The calculated K_{L}, Qₘ and correlation coefficient are given in Table 4. Resorcinol adsorption capacity of OMC was found to be 40.5 mg/g.

The Freundlich Adsorption Isotherm is empirical in nature and can be applied to non-ideal adsorption on heterogeneous surface as well as multilayer adsorption. The equation representing Freundlich adsorption can be expressed as:

$$ln {Q}_{e} = ln {K}_{F} + \frac{1}{n} ln {C}_{e}$$

Where Qₑ is the amount of resorcinol adsorbed at equilibrium (mg/g), Cₑ is the equilibrium concentration of resorcinol. K_{F} and n are the Freundlich constants where n describes the efficiency of adsorption process and K_{F} is defined as an adsorption coefficient representing the amount of adsorbate adsorbed on the adsorbent at unit equilibrium concentration. The values of K_{F} and 1/n are obtained from the intercept and slope of the plot of ln Qe vs. ln Ce as shown in FIG. 8(b). For resorcinol adsorption on the surface of OMC, the values of K_{F} and n are listed in Table 4. K_{F} and n obtained from the experiment were 22.62 mg/g (L/mg)^{1/n} and 4.34, respectively. McKay et al. reported that n value of 2-10 indicates favorable adsorption. The n value of 4.34 for resorcinol adsorption suggests that synthesized OMC is effective for adsorption. The value of 1/n was found as 0.23. The value of 1/n ranging between 0 and 1 is a measure of adsorption intensity or surface heterogeneity. The surface is more heterogeneous when the value of 1/n gets closer to zero. Higher fractional values of 1/n (0<1/n<1) indicate a fair validity of Freundlich isotherm over the entire concentration range, whereas a value above one is an indication of cooperative adsorption.

These results reveal that the Langmuir isotherm model can describe the experimental data fairly well which is concluded based on correlation coefficient. The adsorption capacities of the prepared mesoporous carbon for the adsorption of resorcinol were comparable to other adsorbent materials reported in the literature. The adsorption of resorcinol onto activated carbon was studied by Kumar et al. and it was found to remove 90% of the initially present resorcinol (1000 mg/L) with an adsorption capacity of 36 mg/g. Liao et al. studied the adsorption of resorcinol onto multi-walled carbon nanotubes (MWCNTs). MWCNTs showed an increased adsorption capacity of 48 mg/g in the pH range of 4-8.

In conclusion, order mesoporous carbon was successfully prepared by the hard template method using COK-19. TEM images revealed the ordered structure of COK-19 silica template and OMC. The adsorption kinetics was found to follow the Pseudo-Second-Order Kinetic Model. The results revealed that Langmuir model was found to be more suitable to describe the adsorption of resorcinol onto ordered mesoporous carbon. The synthesized OMC has an adsorption capacity of 40.5 mg/g for resorcinol removal.

We claim:

1. A process to produce a synthesized carbon media comprising:
(a) preparing a silica scaffold;
(b) impregnating a carbon precursor into void spaces of the silica scaffold;
(c) heating the carbon precursor in the silica scaffold to form a polymerized carbon precursor;
(d) carbonizing the polymerized carbon precursor; and
(e) dissolving the silica scaffold with an acid.

2. The process of claim 1 wherein the silica scaffold is COK-19.

3. The process of claim 1 wherein the carbon precursor is sucrose.

4. The process of claim 1 wherein the acid is hydrofluoric acid.

5. The process of claim 1 wherein the heating step occurs between 70° C. and 200° C.

6. The process of claim 1 wherein the carbonizing step occurs between 450° C. and 900° C. for 3 to 9 hr.

7. A synthesized carbon media produced by the method of claim 2.

8. A synthesized ordered mesoporous carbon which comprises:
(a) a carbon lattice formed by means of the following steps:
(b) impregnating a carbon precursor into the mesopores of a silica scaffold;
(c) heating the carbon precursor in the silica scaffold to form a polymerized carbon precursor;
(d) carbonizing the polymerized carbon precursor; and
(e) dissolving the silica scaffold with an acid.

9. The composition of claim 8 wherein the silica scaffold is COK-19.

10. The composition of claim 8 wherein the carbon precursor is sucrose.

11. The composition of claim 8 wherein the acid is hydrofluoric acid.

12. The composition of claim 8 wherein the synthesized ordered mesoporous carbon has an adsorption capacity of at least 35 mg/g for an organic or inorganic compound.

13. The composition of claim 8 wherein said synthesized carbon medium has surface area of at least 900 square meters per gram.

14. The composition of claim 8 wherein said synthesized carbon medium has a pore size of at least 6 nanometers.

15. The composition of claim 8 wherein said synthesized carbon has a total pore volume of at least 1 cubic centimeter per gram.

16. The composition of claim 8 wherein said synthesized carbon medium contains at least 0.10 mmol/g acidic functional groups.

17. The composition of claim 8 wherein the synthesized carbon media is effective in removing a compound from a liquid stream.

18. The composition of claim 8 wherein the synthesized carbon media is effective in removing a compound from a gaseous stream.
